(19) United States
(12) Patent Application Publication
(10) Pub. No.: US 2006/0041458 A1
(43) Pub. Date: Feb. 23, 2006

(54) Scenario editors and scenario rules aggregators for resource-allocation systems

(75) Inventors: Robert P. Ringrose, Somerville, MA (US); Sundar Narasimhan, Boxford, MA (US); Stephen Fleming, Weymouth, MA (US); Jonathan G. Bliss, Pullman, WA (US); Philippe Brou, Boston, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: Ascent Technology, Inc., Cambridge, MA (US)

(21) Appl. No.: 11/179,073

(22) Filed: Jul. 11, 2005

Related U.S. Application Data
(60) Provisional application No. 60/586,736, filed on Jul. 9, 2004.

(51) Int. Cl. G06F 17/50

(52) U.S. Cl. 705/7

(57) ABSTRACT

The present disclosure relates to scenario-management systems for use in resource-allocation systems. In an exemplary embodiment, a scenario editor comprises means for creating, editing, and storing business rules, rule groups, and in a database; and means for creating links among selected business rules, rule groups, and scenarios, such that changes to a first business rule, rule group, or scenario are reflected in a second business rule, rule group, or scenario linked to the first. In further embodiments, the scenario editor further comprises means for associating a scenario with a particular time period. In a further exemplary embodiment, a scenario-management system comprises a central database of business rules, and a processor configured to identify an active scenario, create a list of rule IDs corresponding to the business rules associated with the active scenario, and pass the list of rule IDs to a resource-allocation module.

### CROSS-REFERENCE TO RELATED APPLICATION

The present application claims the benefit of U.S. Provisional Patent Application Ser. No. 60/586,736, which was filed on Jul. 9, 2004, entitled Scenario Editor, and is hereby incorporated by reference.

### BACKGROUND OF THE INVENTION

1. Field of the Invention

This disclosure relates to systems for the creation and use of scenarios that represent and/or simulate sets of constraints and operational conditions under which resources are allocated by resource-allocation systems.

2. Background Information

The problem of resource allocation arises in a wide variety of business environments in which it is necessary to structure the use at a business facility of limited resources such as worker hours, machinery, and/or equipment according to constraints imposed by such considerations as physical space, demand for services offered by the facility, and/or worker contracts. Any such resource allocation ideally should optimize the efficiency of the facility while minimizing operating costs.

For small facilities, where there are only a small number of resources to allocate and relatively few external constraints on the allocation of resources, manual resource allocation—such as a manager working with pencil and paper to staff shifts and distribute tasks and equipment—can be adequate. However, manual resource allocation rapidly becomes infeasible as the number and variety of resources and constraints grows. For a large facility, such as an airport, with hundreds to thousands of workers, tasks, and items of equipment to coordinate under a vast number of external constraints, automated resource allocation is necessary.

It is desirable for an automated resource-allocation system to have access to the full range of constraints and operational conditions under which the resources are to be allocated at a particular time. Existing resource-allocation systems frequently rely on data stored in a variety of disparate locations, making it difficult to change the constraints and operational conditions. Existing resource-allocation systems are also limited to allocations under a single set of constraints and/or at a single time, and can neither adjust to changing conditions nor provide a ready means for testing resource allocations under postulated conditions.

### SUMMARY OF THE INVENTION

The present inventors have developed a system for creating and editing scenarios for use with resource-allocation systems that addresses the above needs and provides additional features and advantages. The systems disclosed herein may store constraints and operational conditions in a single, centralized database that is fully customizable by the user, to facilitate the adjustment of the constraints and operational conditions as necessary, without requiring the entire system to be reprogrammed. In addition, the systems disclosed herein can be used to plan resource allocation for periods of time over which the constraints and/or operational conditions may be changing, as well as allowing the user to simulate changes to constraints and/or operational conditions in order to discover the effects of such changes on resource allocation. The systems disclosed herein may also include a scenario rules aggregation module, which can operate at run time with a resource-allocation program to gather rules from the central database and pass them to the resource-allocation program. These and other aspects of the resource-allocation system are discussed more fully below.

In one aspect, a scenario-management system for use in a resource-allocation system comprises a central database comprising a plurality of business rules, each of the business rules corresponding to a rule ID; and a processor configured to receive a scenario ID corresponding to an active scenario associated with a set of business rules in the database; create a list of the rule IDs corresponding to the set of business rules; and pass the list to a resource-allocation module. In further embodiments, at least some of the business rules in the set of business rules associated with the scenario are organized into rule groups.

In another aspect, a scenario-management system for use in a resource-allocation system comprises a central database comprising a plurality of business rules, each of the business rules corresponding to a rule ID; and a processor configured to refer to a schedule associating at least one scenario ID with at least one time period, to identify a scenario ID corresponding to a scenario associated with a specified time and with a set of business rules in the database; create a list of the rule IDs corresponding to the set of business rules; and pass the list to a resource-allocation module. In further embodiments, at least some business rules in the set of business rules associated with the scenario are organized into rule groups.

In another aspect, a scenario editor for use with a resource-allocation system comprises means for creating, editing, and storing objects in a database, the objects comprising at least one business rule associated with a rule ID and at least one scenario associated with a scenario ID and further associated with at least one business rule; and means for creating links among selected objects, such that changes to a first object are reflected in a second object linked to the first object. In further embodiments, a scenario editor may further comprise means for associating a time period with a scenario ID corresponding to an active scenario for the time period. In still further embodiments, the objects further comprise at least one rule group associated with a rule group ID and with at least one business rule. In still further embodiments, at least one of the at least one scenarios is further associated with at least one rule group. And in still further embodiments, a scenario editor may further comprise means for associating a time period with a scenario ID corresponding to an active scenario for the time period.

In another aspect, a scenario-management system comprises means for creating, editing, and storing objects in a database, the objects comprising at least one business rule associated with a rule ID and at least one scenario associated with a scenario ID and further associated with at least one business rule; means for creating links among selected objects, such that changes to a first object are reflected in a second object linked to the first object; and a processor configured to receive a scenario ID corresponding to an active scenario, the active scenario being associated with a set of business rules in the database; create a list of the rule IDs corresponding to the set of business rules associated with the active scenario; and pass the list to a resource-allocation module. In further embodiments, the objects further comprise at least one rule group associated with a rule group ID and with at least one business rule. In still further embodiments, at least one of the one scenarios is further associated with at least one rule group.

In another aspect, a scenario-management system comprises means for creating, editing, and storing objects in a database, the objects comprising at least one business rule associated with a rule ID and at least one scenario associated with a scenario ID and further associated with at least one business rule; means for creating links among selected objects, such that changes to a first object are reflected in a second object linked to the first object; and a processor configured to refer to a schedule associating at least one scenario ID with at least one time period, to identify a scenario ID corresponding to an active scenario associated with a specified time, the active scenario being associated with a set of business rules in the database; create a list of the rule IDs corresponding to the set of business rules associated with the active scenario; and pass the list to a resource-allocation module. In further embodiments, the objects further comprise at least one rule group associated with a rule group ID and with at least one business rule. In still further embodiments, at least one of the one scenarios is further associated with at least one rule group.

### BRIEF DESCRIPTION OF THE DRAWINGS

The invention description below refers to the accompanying drawings, of which:

FIG. 1 is a schematic diagram of the structure and operation of an embodiment of a resource-allocation system;

FIG. 2 is a schematic illustration of linked copies of database objects (FIG. 2A) and unlinked copies of database objects (FIG. 2B);

FIG. 3 is an exemplary representation of a database entry corresponding to a constraint;

FIG. 4 is an exemplary representation of a database entry corresponding to a constraint;

FIG. 5 is a plot of an exemplary passenger arrival profile;

FIG. 6 is a plot of an exemplary passenger arrival profile typical of a short commuter flight;

FIG. 7 is an exemplary plot of the number of check-in counters needed for a flight as a function of time before departure;

FIG. 8 is a flow chart schematically illustrating an exemplary embodiment of a scenario rules aggregator; and

FIG. 9 is a flow chart schematically illustrating an exemplary embodiment of a scenario editor.

### DETAILED DESCRIPTION OF AN ILLUSTRATIVE EMBODIMENT

To provide an overall understanding, certain illustrative embodiments will now be described; however, it will be understood by one of ordinary skill in the art that the devices and methods described herein can be adapted and modified to provide devices and methods for other suitable applications and that other additions and modifications can be made without departing from the scope of the systems described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, specified, interchanged, and/or rearranged without departing from the disclosed devices or methods.

The scenario creation and editing systems described herein can be employed in resource-allocation systems for any of a wide variety of business environments in which the allocation of resources such as (without limitation) worker time, equipment, machinery, and/or supplies need to be distributed under constraints such as (without limitation) physical space, demand for services, worker contracts, and/or operational conditions. Such business environments may include airports, entertainment venues such as casinos and amusement parks, rental car facilities, large retail establishments such as supermarkets or big-box outlets, etc. Although exemplary embodiments of the system are described herein with reference to the constraints and operating conditions under which resource allocation occurs at airports, it will be understood that the principles and systems described are readily extendable into any business environment in which resource allocation problems are encountered.

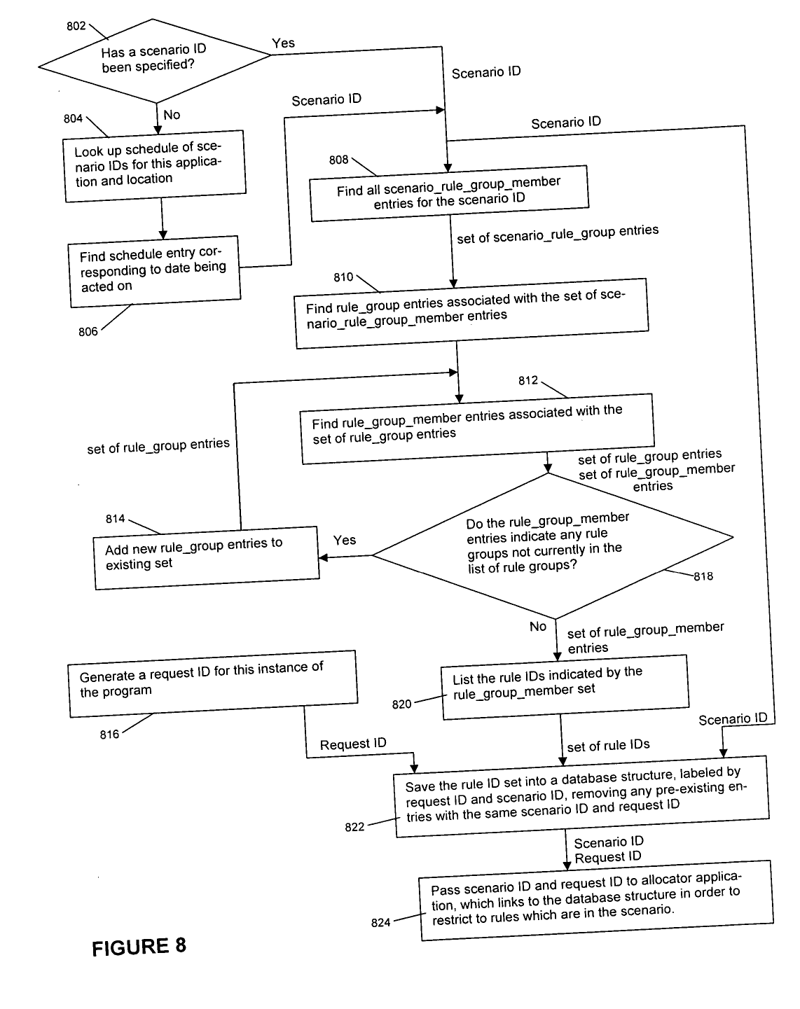

Throughout this disclosure, the term “scenario editor” will be used generally to refer to exemplary systems for creating, editing, and managing scenarios for use with a resource-allocation system. An exemplary scenario editor may include and/or interact with a database of rules and operational data (discussed further below). A resource-allocation system may also include a software layer or module, termed herein “scenario rules aggregator,” that gathers from the database all the rules associated with a particular scenario and passes the rules to the resource allocation module for application to the operational data and generation of resource-allocation plans or other output. The operation of an exemplary scenario rules aggregator is discussed further below, particularly in connection with FIG. 8.

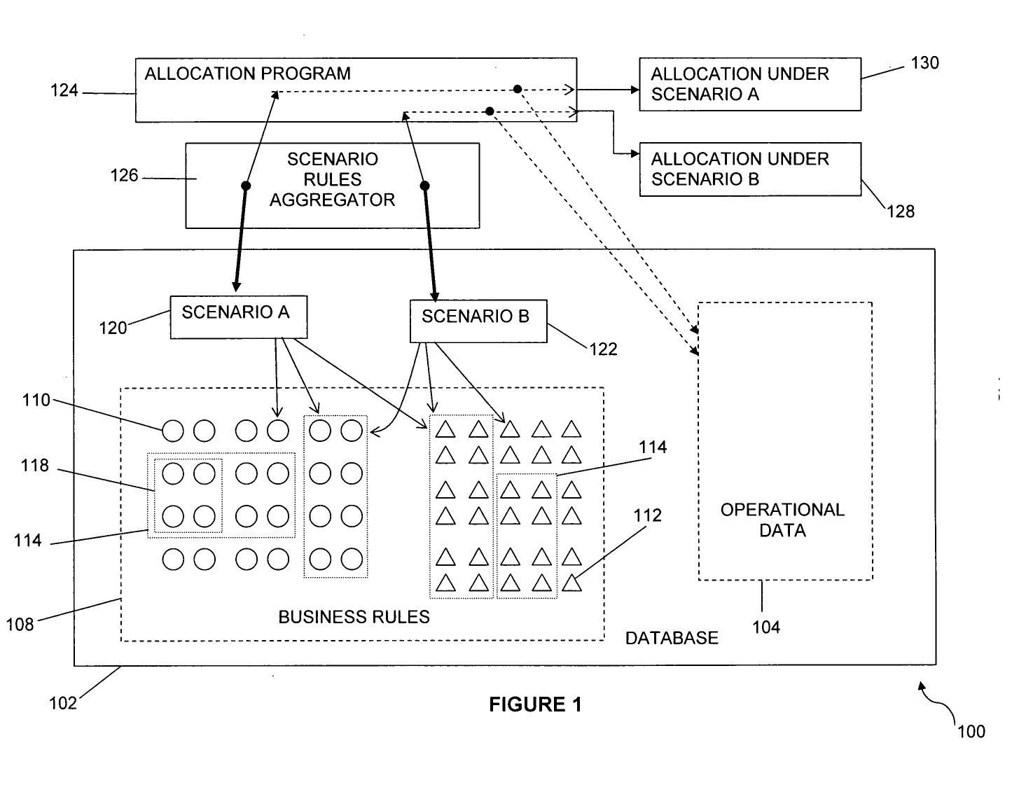

A schematic representation of an exemplary resource-allocation system in which a scenario editor may be used is illustrated in FIG. 1. A general overview of the components of the exemplary resource-allocation system 100 illustrated in FIG. 1 is provided here; exemplary components are discussed in further detail below.

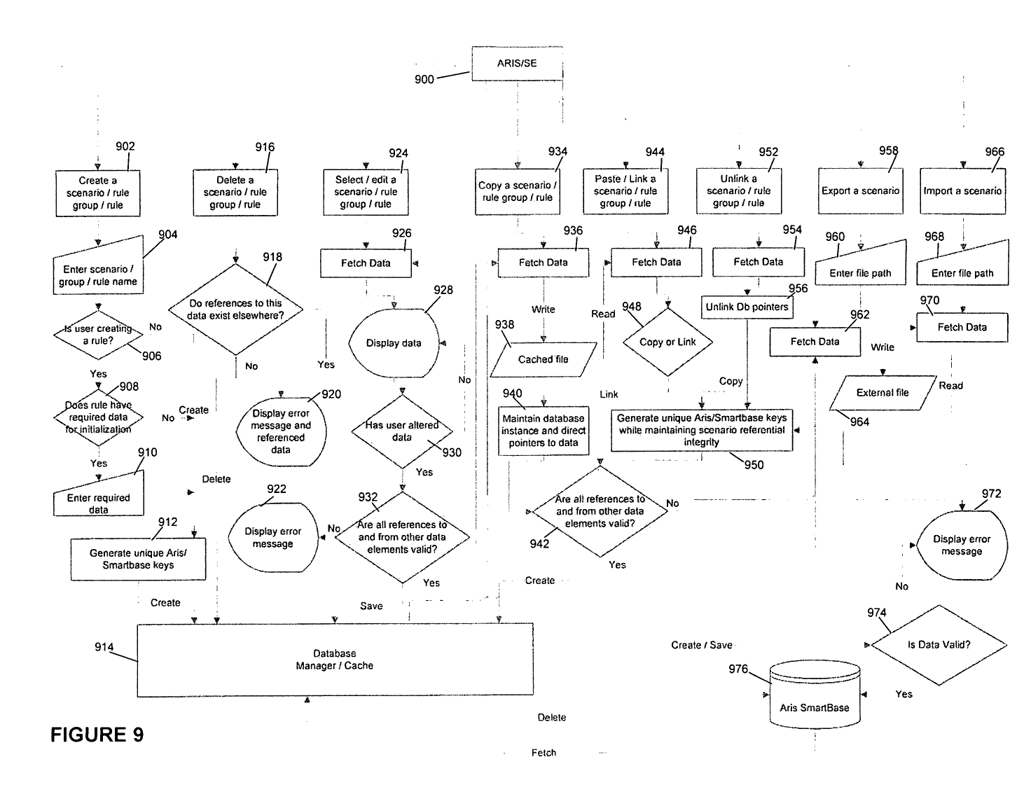

An exemplary resource-allocation system 100 is implemented on a computer system that includes a storage medium and at least one processor. A resource-allocation system may include a central database 102, stored in the storage medium. An exemplary database 102 contains operational data 104 and business rules 108. Business rules 108 m a y include both resource rules 110 and constraints 112. Business rules may be organized into rule groups (exemplified by 114). In addition, rule groups may contain other rule groups (exemplified by 118) as well as individual rules. A scenario editor may interact with this database to provide means for creating, editing, and managing rules and rule groups, as discussed further below, particularly in connection with FIG. 9.

Returning to FIG. 1, also stored in database 102 is at least one scenario (120, 122). Scenarios, which may be user-created using a scenario editor, point to selections from among the business rule groups and individual business rules. An exemplary resource-allocation system includes an allocation module 124, running on the processor of the computer system. The allocation module 124 may receive from the scenario rules aggregator a set of business rules associated with one or more active scenarios (120, 122). The allocation module applies those business rules to the operational data 104 and may produce as output a resource allocation plan (128, 130) corresponding to each scenario. A resource allocation plan (128, 130) may assign a task or function to each resource identified as available in the scenario. Other inputs (not illustrated) to the allocation program 124 may include time periods over which each scenario is active. Time-dependent information may alternatively and/or additionally be encoded in the scenarios (128, 130) or the business rules (110, 112).

The allocation program 124 generates allocation plans (128, 130) that are optimized in some desirable parameter or parameter. For example, the allocation plans may be optimized for lowest operating costs, smallest number of resources allocated, least idle time for existing resources, or other parameters. As discussed further below, business rules may include penalty scores that encourage or discourage particular allocations; the allocation program 124 may generate allocation plans optimized on such penalty scores as well. In general, the allocation program 124 may generate allocation plans optimized for a single such parameter, or for a combination of several parameters (e.g., minimizing both operational cost and penalty score to the extent possible).

These and other aspects of an exemplary resource-allocation system are discussed in further detail below.

Database.

An exemplary resource-allocation system may include a central database in which all the information necessary for resource allocation is stored. The central database is the repository for at least two categories of information, which are referred to herein as “operational data” and “business rules.”

“Operational data” include facts about the business environment and the resources to be allocated. For example, in the context of resource allocation at an airport, operational data may include flight data and scheduling information; specifications of the resources to be allocated (e.g., number and capacity of baggage carousels); information about individual workers at the business facility (such as their work schedules and/or qualifications); and/or other similar facts. Operational data may also include data such as the load information (e.g., number of passengers and number of bags) pertaining to particular flights on a particular day. Such operational data that changes with each flight, or any other operational data that changes with time, can be dynamically updated as needed. The types of operational data listed here are exemplary; any factual information about the resources to be allocated or the business environment in which the allocation is to take place may be included in the operational data.

“Business rules” are database records that guide the system to make resource-allocation decisions automatically. They include rules defining the resources available for allocation (“resource rules”) as well as the external constraints imposed upon the resource allocation (“constraints”). For example, in the context of resource allocation at an airport, business rules may include the number and types of workers needed to handle check-in for each type of flight (e.g., domestic or international, type of plane, etc.); worker wage schedules; physical information about the airport (e.g. number, capacity, and layout of gates, check-in counters, security screening areas, baggage carousels, amenities, etc.); etc. Business rules may also include any constraints on the uses of particular gates, such as restrictions on the type of aircraft for which a particular gate is suitable, restrictions on which airlines may use particular gates, or preferences for particular types of flights to be located at particular gates. Business rules may also include the terms of worker contracts, such as the maximum number of hours per shift and/or duration and frequency of breaks. The types of business rules listed here are exemplary; any constraints that may apply to the allocation of resources may be included in the business rules. Exemplary business rules are described in further detail below.

The database may also include information that may be considered reference data. Reference data may include information that is generally fixed, such as the general characteristics of the assets of the business environment, the physical characteristics and/or preferences of average users of the business environment, etc. In the context of resource allocation at an airport, the reference data may include lists of names and locations of airports; aircraft size and physical characteristics; and/or the average walking pace of airport passengers.

It should be noted that the distinctions between business rules and reference data, and between operational data and reference data, are arbitrary and conceptual, and do not in any way limit the descriptions of rules, rule groups, and scenarios, all of which may contain references to information classified in any of the above categories.

Rules of any type may be organized within the database into rule groups. A rule group may contain individual rules and/or other rule groups. Rule groups may include a collection of rules that have something in common that is a useful organization unit. For example, there may be a group for Gate rules, a group for Stand rules, and/or a group for Check-in counter rules, etc. Rule groups allow the manipulation of a plurality of rules in a set that can be conveniently activated or deactivated together as desired. Such rule groups may facilitate the selection of rules for scenarios, discussed below. For example, in the context of resource allocation at an airport, a complete set of rules could be created representing proposed terms in a labor contract. This complete set of rules could then be incorporated into a scenario, using, for example, a scenario editor as described below. Where a scenario editor and resource allocation system is used for analysis of the proposed terms, i.e., to observe the effects on resource allocation of changing the labor contract in accordance with the proposed terms, the entire rule group can be switched in and out of a scenario without requiring the user to identify and change dozens of individual rules. The creation, editing, and management of rule groups using an exemplary scenario editor is discussed further below.

Resource Rules.

In an exemplary resource-allocation system, resource rules are stored as entries in the database. (The creation and editing of all types of rules using a scenario editor is described further below.) Each rule has a unique ID, along with numerous data fields in which all of the information needed to specify the rule is encoded. In an exemplary embodiment, resource rules may be organized in a tree structure, with higher level rules that include groupings of lower-level rules. For example, in the context of a resource-allocation system for managing an airport, exemplary top-level rules include an Airport Resources rule. The Airport Resources rule includes lower-level resource rules defining the physical resources of the airport. For example, the user may define one or more Terminal rules associated with the Airport Resources rule. Each Terminal rule may have fields for such attributes as terminal name, terminal ID, airport, description, etc. In addition, each Terminal rule may have a unique rule ID associated with it. In an exemplary embodiment, each Terminal rule also includes fields that determine whether the resource-allocation system operates to allocate resources for the particular terminal; whether manual approval is needed for an allocation determined by the system; and/or whether the terminal is active.

In turn, the user may define Gate and Stand rules associated with a particular terminal. These rules contain attributes of each gate and stand within that terminal. (A “stand” is a location at which an aircraft may be parked. A “gate” is a door or area in a terminal used by passengers for boarding and disembarking aircraft located at an associated stand.) In an exemplary embodiment, Gate rules include fields for such attributes as name, description, whether the gate or stand is suitable for international arrivals (i.e. whether the gate is behind the Customs area), etc. Similarly Stand rules may include fields for name, description, associated gate(s), etc.

Similarly, resource rules may be created that correspond to other physical resources of the airport, such as check-in areas, check-in counters, baggage handling resources for both arriving flights and departing flights, etc.

The above resource rules are exemplary only. Other fields that can be included in the various resource rules and other resource rules that may be useful for a particular business environment will be readily appreciated.

In the context of resource allocation at an airport, an exemplary resource-allocation system may also include airline rules defining each of the airlines that has flights arriving at or departing from the airport. Airline rules may further be organized into groups. For example, airline rules may be grouped where the corresponding airlines share a terminal, a pier, check-in or baggage-handling areas, or other airport resources.

Further in the context of resource-allocation at an airport, an exemplary resource-allocation system may also include aircraft rules defining all of the aircraft types that fly to or from the airport. Aircraft rules may include fields for such aircraft features as size or size category, passenger and cargo capacity, and other features relevant to the allocation of resources for flights using the specified aircraft. Aircraft rules may further be organized into groups. For example, aircraft groups may be organized according to the size of the aircraft, e.g., to distinguish larger aircraft from smaller aircraft, which can be useful when defining constraints on available parking positions (stands) for types of aircraft.

Constraints.

In addition to the resource rules that define the resources available for allocation, an exemplary resource-allocation system also includes constraints, encoded in business rules, that limit or affect the allocation of resources. Some such resource allocation constraints may be absolute constraints on resource allocation, i.e., conditions that must be met in order for an allocation to be acceptable. Other constraints may be expressed conditionally. Such conditional rules may be assigned a penalty, indicating a degree of preference associated with that condition. Conditional rules and penalties are discussed further below. Some exemplary constraints are described below.

In the context of resource allocation at an airport, the constraints on the allocation of stands for arriving and departing flights may include physical limitations which aircraft can safely park at a particular stand without interfering with other aircraft parked at adjacent stand. For this reason, an exemplary resource-allocation system may include a stand allowed aircraft rule specifying the specifying the aircraft types that are permitted to park and forbidden from parking at each stand. When computing an optimal allocation of resources, the system will not allocate any stand to a flight that uses an aircraft type forbidden to park at that stand. In an exemplary embodiment a stand allowed aircraft rule is a database entry that may include the following fields: stand identifier (corresponding to a resource rule defining the stand); permitted aircraft types or aircraft groups; and/or a field for creating exceptions (forbidden aircraft types) within permitted aircraft groups.

Another constraint may be provided by Gap Spec rules, which establish the minimum amount of time between the departure of one aircraft from a stand and the arrival of the next aircraft at the same stand. Gap Spec rules include a field for specifying the gap time, for example, in minutes. Because the time required to maneuver aircraft in and out of a stand may depend upon the size of the aircraft, a resource-allocation system may include multiple Gap Spec rules that are invoked according to the aircraft types allocated to the stand. For example, an embodiment of the resource-allocation system may include one Gap Spec rule for a narrow body aircraft departure and a narrow body aircraft arrival; one for narrow body-widebody; one for widebody-narrow body; and a fourth for widebody-widebody.

Another exemplary constraint that is applicable in the context of resource allocation at an airport can be embodied in Aircraft Time Information rules. In an exemplary resource-allocation system, Aircraft Time Information rules establish the length of time an aircraft needs to occupy a stand after arrival (for passengers to deplane) and/or before departure (for passengers to board). Because these times can vary with the type of aircraft, a resource-allocation system may have Aircraft Time Information rules defined for each aircraft type or for each group of aircraft types.

As noted previously, an exemplary resource-allocation system includes conditional rules. Conditional rules may be based upon logic statements in the form of “if x, then y.” Exemplary conditional rules may be thought of as having two main components: a violation pattern (or patterns), and a numerical penalty. The violation pattern is a collection of constraints or problems for a particular class of resource allocation. The penalty is a numerical indication of how undesirable the violation is. In an exemplary embodiment, the penalties may range from 0 (no violation) to 1000 (indicating an unacceptable resource allocation). As the resource-allocation system attempts to optimize the allocation of resources, it checks any particular allocation against the active conditional rules to determine whether any of the violation patterns is met. When a rule's violation pattern matches the features of the particular resource allocation, the penalty associated with that rule is included in the overall penalty computed for the allocation. (The overall penalty may be computed as an arithmetic combination of all assigned penalties, such as a sum or a product.) In an exemplary resource-allocation system in which the maximum penalty indicates an allocation that is unacceptable under any circumstances, the system will reject any allocation that matches a violation pattern associated with the maximum penalty. As long as no maximum penalty violations occur, the system will reallocate resources until the total penalty is minimized.

In an exemplary embodiment, there are two types of conditional rules: simple constraint rules and conflict constraint rules. A simple constraint rule contains one violation pattern that looks at a single assignment of a particular resource. A conflict constraint rule contains at least two violation patterns: one for a particular resource being assigned, and others for other resource assignments that might cause a conflict. In other words, simple constraint rules assign penalties to problems arising from the assignment of a single resource, while conflict constraint rules identify and assign penalties to problems that arise from the simultaneous allocation of multiple resources.

The following examples illustrate simple and conflict constraint rules in the context of resource allocation at an airport. An example of a simple constraint rule is:

### EXAMPLE 1

Pattern: The current stand is Stand 21, the time is after 10:30, and the aircraft is a 747-400

If the pattern is matched, then assign a penalty of 1000.

This rule makes it unacceptable to assign a 747-400 aircraft to Stand 21 after 10:30.

An example of a conflict constraint rule is:

### EXAMPLE 2

Pattern #1: The current stand is Stand 41
Pattern #2: Stand 40 is not open, and the aircraft at stand 40 is a DC9, a 737-200, or a 737-300.

If the pattern is matched, then assign a penalty of 1000. This rule makes it unacceptable to assign any aircraft to Stand 41 at the same time that there is a DC9, a 737-200, or a 737-300 assigned to Stand 40.

Conditional rules may also be used to assign preferences for particular resource allocations that are not unacceptable, but that are undesirable to varying degrees. For example, in the context of resource allocation at an airport, if Air France prefers its flights to be assigned to gate A7 or A9, a simple constraint rule may be created as follows:

### EXAMPLE 3

Pattern: The current airline is Air France, and the Gate is not A 7 or A9

If the pattern is matched, then assign a penalty of 20.

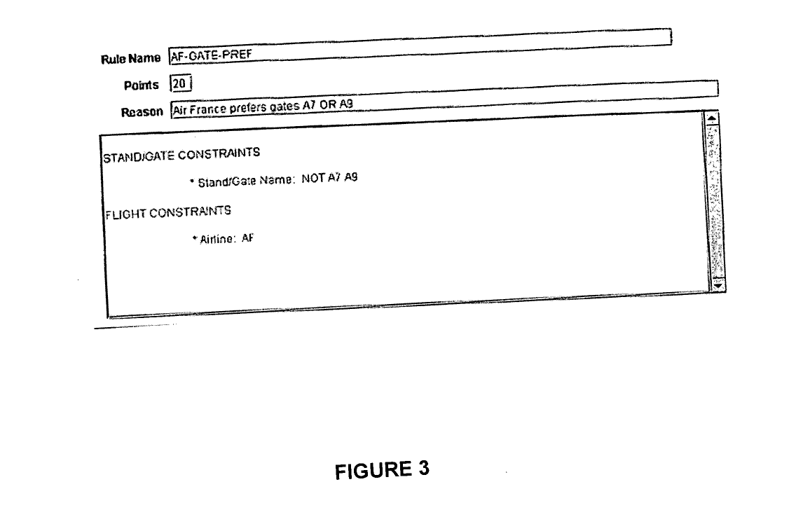

The higher the penalty value, the stronger the preference, and the more likely an optimized resource allocation will be in accordance with the preference. An exemplary embodiment of a database entry expressing the above rule is illustrated in FIG. 3.

Another example can illustrate the interplay between defined resource rules and rules groups with constraints. If the airport has a number of stands that are not associated with gates in passenger terminals, the resource-allocation system can be made to ensure that cargo flights are assigned to these remote stands using a resource rule group including all of the remote stands and applying the following simple constraint rule:

### EXAMPLE 4

Pattern: The current flight is a cargo flight, and the current stand is not in the remote stand group

If the pattern is matched, then assign a penalty of 1000.

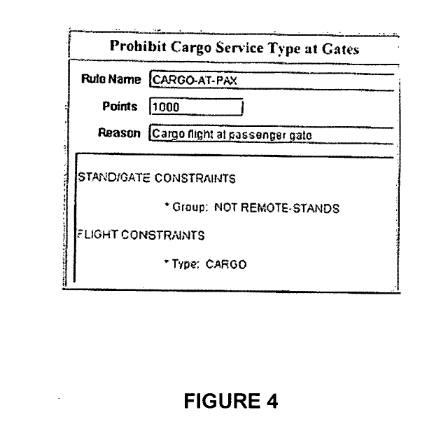

An exemplary embodiment of a database entry expressing the above rule is illustrated in FIG. 4.

A resource-allocation system for an airport may also include rules for allocating baggage claim belt times to incoming flights. Such a rule may be relatively general, specifying only a particular time for a particular type of aircraft (i.e., 45 minutes for an incoming 747), or it may further specify other parameters such as the airline and/or the origin of the flight (i.e., 45 minutes for a 747 arriving from a domestic destination, but 60 minutes for a 747 arriving from an international destination). Rules for allocation of particular baggage claim belts (defined by resource rules) to particular flights may take a similar form to the gate assignment rule illustrated in Example 3 above.

Penalties may be constructed to encourage the system to distribute tasks to the least-stressed resources. For example, in the context of resource allocation at an airport, a baggage belt allocation rule may add 100 penalty points to the total for each additional flight assigned to a baggage belt after a first flight has been assigned to it. Penalties can similarly be employed to discourage or prevent the assignment to a single baggage belt of multiple large-aircraft flights.

Similar rules may be created to control the allocation of check-in counter resources and other airport resources. The resource-allocation system may refer to fields in the aircraft resource rules to determine the number of counter-minutes needed for each departing flight listed in the flight schedule stored in the operational data.

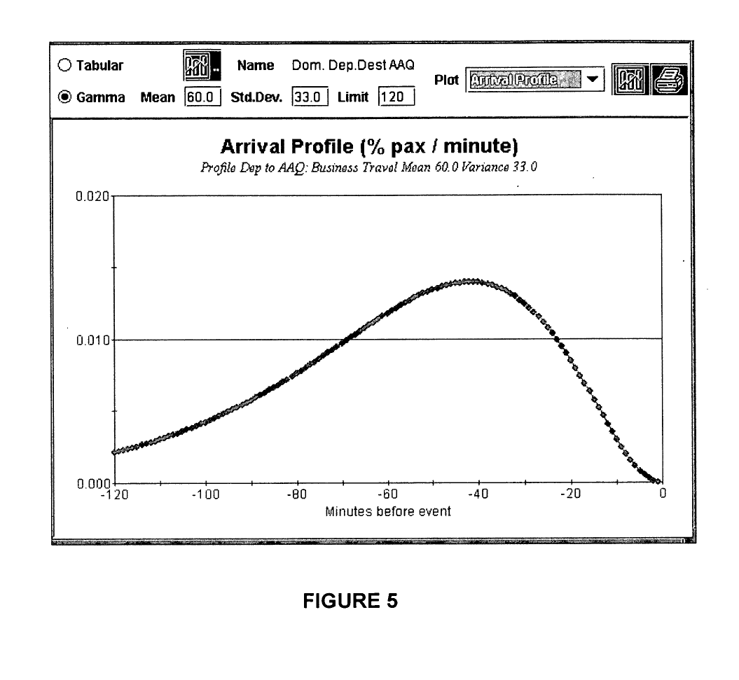

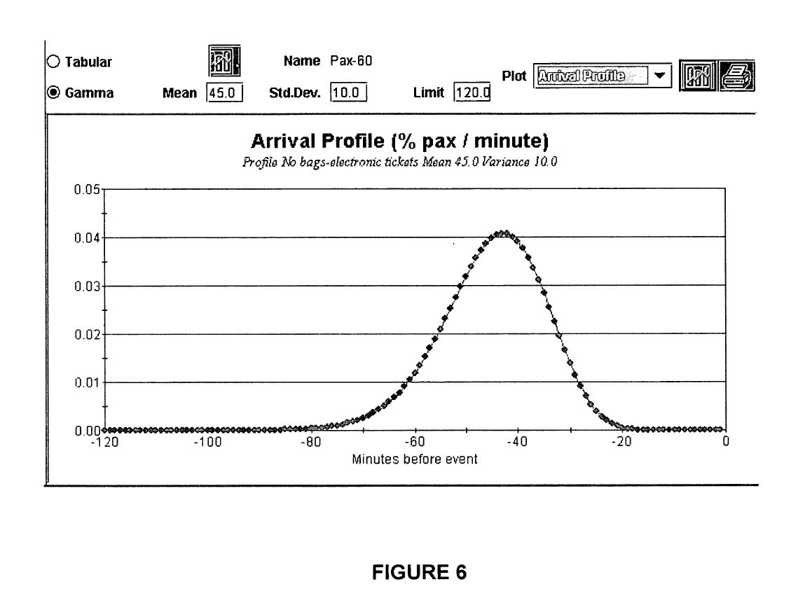

The rules for controlling allocation of check-in counter resources may further refer to an expected passenger arrival profile such as the profiles illustrated in FIGS. 5 and 6. The passenger arrival profile plots the number of passengers arriving for check-in per minute, plotted against the number of minutes before the flight's scheduled departure. Passenger arrival profiles may vary depending upon the type of flight. For example, passengers tend to arrive earlier for international flights, while travelers on short-hop commuter shuttles tend to arrive at check-in much closer to departure time, as can be seen by comparing FIG. 6, which is typical of a commuter flight, with FIG. 5, more typical of a longer flight in which passengers are likely to check bags. Passenger arrival profiles may also vary with the expected load factor of the flight. Thus different flights may be associated in the database with different passenger arrival profiles. These passenger arrival profiles may be stored in passenger profile rules as tabulated data or as functions whose values can be computed analytically when needed. The appropriate shape, peak, and width of the profile may be determined empirically by observing passenger behavior for different types of flights, and/or modeled.

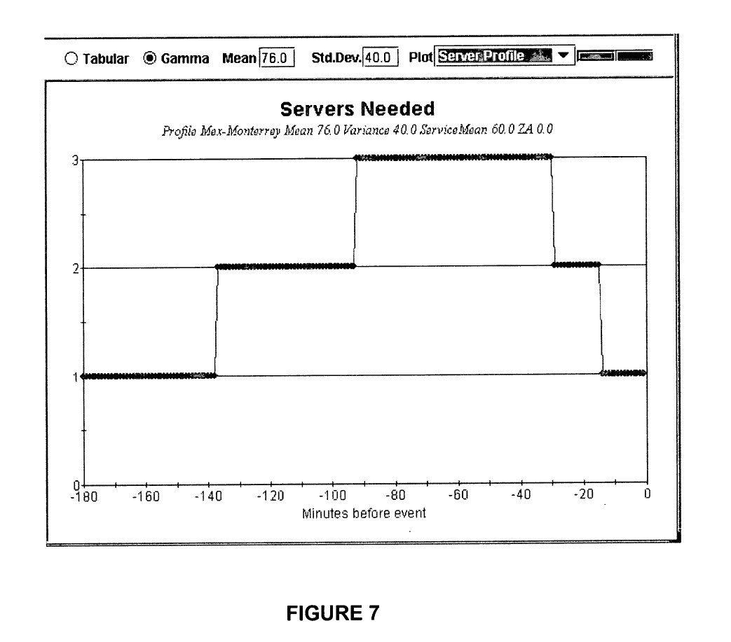

The resource-allocation system may convert the passenger arrival profile into a profile of the number of check-in counters needed as the time of departure approaches, as illustrated in FIG. 7. In an exemplary embodiment, a resource-allocation system refers to a Service Time rule for this conversion. The Service Time rule specifies the average time required for a counter agent to check in one departing passenger. A Service Time rule may include different amounts of time for different types or classes of passenger. After determining the number of check-in counters needed, the resource-allocation system may then allocate the appropriate number of counters for each time leading up to departure.

A further class of rule in an exemplary resource-allocation system in the context of an airport is a passenger load factor rule. Such a rule may be used to refine estimates of passenger traffic by estimating how full particular flights are likely to be. Passenger load factor rules may refer to aircraft resource rules in which the number of seats on each type of aircraft is stored. The load factor rule allows the resource-allocation system to compute the number of seats expected to be sold, based upon types of flights, time of day, season, destination, and/or other attributes.

An exemplary system may also include business rules defining the number and qualifications of workers needed to perform particular tasks. Thus, for example, in addition to the rules described above that the resource-allocation system uses to determine how many check-in counters and/or how many minutes of baggage belt time is assigned to a particular flight, the resource-allocation system may also use business rules to staff the check-in counters and/or baggage belts. Business rules may also include rules defining worker wages and similar costs associated with assigning resources to particular tasks. An exemplary resource-allocation system may use these rules to compute costs associated with particular allocations and, if desired, optimize the resource allocation for lowest cost.

The above constraints and rules are exemplary only, and are not meant to represent an exhaustive list of constraints that may be encoded in rules and stored in the database of a resource-allocation system. In the context of resource allocation at an airport, those skilled in the art will recognize a variety of other applicable constraints. Generally, constraints arise from the physical configurations, costs, availability, and other limitations on the allocation of resources in any particular business environment.

Like resource rules, constraints and/or business rules are stored in the central database. Each is identified by a unique identifier, and may have numerous data fields in which all of the information needed to specify the rule is encoded.

Scenarios.

In an exemplary resource-allocation system, a selection of business rules may be organized into and/or associated with a “scenario.” An exemplary scenario is a highly-structured statement of the business environment's resources and capacities, combined with the business rules for the business environment. The detailed specifications in a scenario form a model of the business environment's operations that can be used the resource-allocation system to manage and allocate resources. A scenario may be thought of as an integrated statement of the logistical challenges presented by resource allocation at a particular time or during a specified time period. At a minimum, an exemplary scenario includes a subset of the business rules in the database. In some embodiments, scenarios may include selections from some or all of business rules, resource rules, reference data, and/or operational data. In an exemplary embodiment, a scenario is a database structure containing pointers to the database IDs of its contents.

In an exemplary embodiment, a scenario comprises a set of rules and/or rule groups that represent the business environment and its operations. In one embodiment, the database may include a set of foundation rules that describe the physical resources of the business environment. For example, in the context of resource allocation at an airport, the foundation rules may describe the airport's physical resources (e.g. number, capacity, and layout of gates, check-in counters, security screening areas, baggage carousels, amenities, etc.) and the characteristics of the aircraft that use the airport. The foundation rules may be shared rules that are incorporated into multiple scenarios.

In an exemplary embodiment, rules are distributed in the database. As the user creates rules using a scenario editor, each rule is stored (for example in a table structure) and identified with a unique ID that may be generated automatically by the scenario editor, as described further below. As the user groups the rules into rule groups, the scenario editor further creates a unique ID for each rule group and stores in the database (for example, in a table) information associating each rule group ID with the rule IDs corresponding to the rules in that group. Similarly, as the user creates scenarios, the scenario editor further creates a unique ID for each scenario and stores in the database (for example, in a table) information associating each scenario ID with the rule group IDs and rule IDs corresponding to the rule groups and rules in that scenario. Because of this database structure and the use of IDs to point to rules stored in the database, users may create linked copies of rules, rule groups, and scenarios (as described further below) without the need to manually manage the large number of individual rules that may be involved.

Although multiple scenarios may reside in the central database simultaneously, in an exemplary embodiment only a single scenario, the “active scenario,” is active at a given time. As described further below, particularly in connection with FIG. 8, an exemplary resource-allocation system includes a scenario rules aggregator that gathers the rules associated with the active scenario and passes them to a resource-allocation module, which operates automatically to optimize resource allocation under the constraints of the active scenario given the current operational data. In an exemplary embodiment, a human user of the scenario editor may be completely unaware of the underlying structure of the database and of the operation of the scenario editor in gathering rules and passing them to the resource-allocation module.

In exemplary embodiments, a resource-allocation system can provide one or more of a variety of outputs. One output may be resource-allocation plans for the current time, a particular day, or an allocation as a function of time over a specified time period. In the context of resource allocation at an airport, a resource-allocation plan may include gate assignments for all incoming and outgoing flights, assignment of check-in counters and baggage belts, and/or worker assignments. The output of a resource-allocation system may also include operating costs associated with the allocation. The output of a resource-allocation system may be a real-time assignment plan taking into account current operational data and active business rules. The resource-allocation system output may provide a warning if it detects a lack of sufficient available resources to meet expected demand. It may also produce graphs plotting resource counts or other parameters as a function of time; differential information comparing an allocation plan with previous allocations; Gantt charts; and/or architectural or building view diagrams showing where and how resources are allocated.

Alternatively or additionally, the output of a resource-allocation system may be a projected resource-allocation plan (including any of the above outputs) applicable to a future time, a future time period, or hypothetical conditions. Such a projected resource-allocation plan may also include the projected operational costs for the future or hypothetical conditions, and/or identify time periods or conditions under which the available resources may be insufficient or only marginally sufficient to meet demand. Thus the resource-allocation system may be used to test, investigate, and/or predict operational costs, resource-allocation problems, and other aspects of resource allocation under varying conditions.

For example, in the context of resource-allocation at an airport, a user of an exemplary resource-allocation system may create a scenario in which a portion of a terminal is closed for renovations for some period of time. The user may then run the resource-allocation system to obtain a projection of the terminal closing's effects on operational cost and efficiency. Because the scenario (or the rules contained in the scenario) can include time-dependent components, the projection may take into account the fact that demand for the airport's services is not constant over time. For example, the scenario used to create the projection may incorporate a rule that assumes all incoming and outgoing flights are filled to 75% capacity (load factor=0.75) unless the date is the day before Thanksgiving or the Sunday after Thanksgiving, in which case all incoming and outgoing flights are assumed to be filled to 95% capacity (load factor=0.95).

As another example, where airport management is negotiating a new contract with the labor union that represents its workers, a user can create scenarios that test the effects that varying contractual terms will have on the costs of operating the airport. Such scenarios may include, for example, increasing worker wages by some amount while simultaneously increasing the maximum shift length or reducing the number of workers available to perform a particular task such as baggage check-in. The results of running the resource-allocation system under such scenarios can provide guidance to airport management in deciding which contractual terms to press for in negotiations and where concessions can be made.

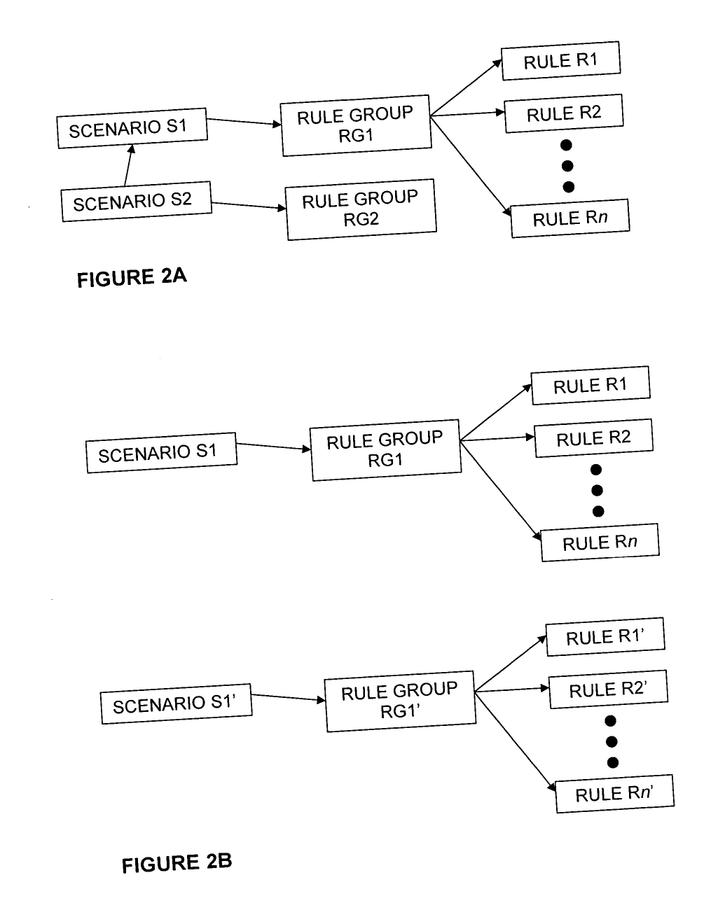

To facilitate the creation of multiple scenarios, particularly in contexts in which the user wishes only to “tweak” a few constraints while keeping all other conditions constant, an exemplary embodiment of a resource-allocation system includes a mechanism for creating links among rules, rule groups, and scenarios, such that when these objects are changed, the change will propagate to all linked objects. The following discussion illustrates some features of this linking capability through the example illustrated in FIG. 2A and FIG. 2B.

Illustrated schematically in FIG. 2A is a scenario S1 containing rule group RG1. In the database, scenario S1 points to rule group RG1 in order to read its data. RG1, in turn, may point to a number of individual rules R1, R2, . . . , Rn. Now any change to the contents of the rules R1, R2, . . . , Rn is reflected automatically in scenario S1 the next time the resource-allocation system loads scenario S1 from the database.

The user may now create a second scenario, scenario S2. If scenario S2 is linked to S1, any change to scenario S1 (or to rule group RG1, or to rules R1, R2, . . . , Rn) is reflected automatically in scenario S2 the next time the resource-allocation system loads scenario S2 from the database. The user may then alter scenario S2 by, for example, including a second rule group RG2 in scenario S2. Changes to RG2 will propagate automatically to scenario S2, but not to scenario S1, because RG2 is not included in scenario R1.

In some embodiments, this linking is achieved by structuring objects to include pointers to the objects they contain, rather than copies of the objects themselves. Thus, when an exemplary resource-allocation system loads scenario S1, the system is pointed in the database to rule group RG1, and from there, in turn, pointed to the instantiations of the rules elsewhere in the database.

Such linking may be desirable, for example, where a user wishes to make small changes to a scenario in order to test a few changes to business rules while keeping the bulk of the business rules constant. In an exemplary resource-allocation system, users may similarly create links among copies of rule groups and among individual rules.

However, because such linking is not always desirable, exemplary embodiments of the scenario editor also include a mechanism by which the user may make unlinked copies of existing objects. Thus, as illustrated in FIG. 2B, for example, a user may create an unlinked copy S1′ of scenario S1 containing a rule group RG1′, which in turn contains copies R1′, R2′, . . . , Rn′ of the rules R1, R2, . . . , Rn. Now, if the user changes the original rules R1, R2, Rn, and the original rule group RG1, the changes will propagate to scenario S1, but not to scenario S1′. Similarly, if the user changes the copies—rules R1′, R2′, . . . , Rn′ or the rule group RG1′—the changes will propagate to scenario S1′, but not to scenario S1.

A user manual for an exemplary embodiment of a scenario editor for use with a resource-allocation system was included in U.S. Provisional Patent Application Ser. No. 60/586,736, incorporated herein by reference, and illustrates several of the features of exemplary scenario editors and rules described above.

Gathering a Scenario and Passing it to the Allocation Program.

An exemplary resource-allocation system includes a scenario rules aggregator module that operates at run time with the resource-allocation system to gather all the rules associated with the active scenario and pass them to the resource-allocation module. Because this aggregation can happen at run time, the scenario rules aggregation module allows the resource-allocation system to flexibly handle changing conditions. For example, the resource-allocation system may check a schedule listing which scenarios are active at which times, before calling the scenario rules aggregator module to gather the rules for the scenario that is currently active.

When an exemplary resource-allocation system is ready to begin resource allocation, it calls the scenario rules aggregator module, which identifies the scenario whose rules it will gather and pass back to the resource-allocation system to apply to the operational data to generate a resource allocation plan or other output. Identification of the active scenario can either occur automatically (e.g., by checking a schedule to determine what scenario is active at a current time), or by user input (e.g., by the user requesting a resource allocation projection for the future and/or under a hypothetical scenario). The scenario rules aggregator then collects all the rules associated with that scenario as described below with reference to FIG. 8.

The exemplary scenario rules aggregator operates on a database that includes rules, rule groups, and scenarios. Each rule in the database may be uniquely identified by a rule ID. Similarly, each rule group may be uniquely identified by a rule group ID. As described above, rule groups contain rules and/or other rule groups. Thus a rule group may be conceptualized as a list of the rule IDs and rule group IDs of the rules and rule groups it contains. Similarly, each scenario is uniquely identified by a scenario ID, and may be conceptualized as a list of the rule IDs and rule group IDs of the rules and rule groups it contains.

In the embodiment illustrated in FIG. 8, when the scenario rules aggregator is activated it generates a request ID (step 816) that can be used to identify this particular call to the scenario rules aggregator and its output. The request ID may identify the particular resource allocation program that invoked the scenario rules aggregator. Alternatively, if the scenario rules aggregator is called as part of a planning request, rather than during a real-time or near real-time run of a resource allocation application, the request ID may identify the planning request. In an exemplary embodiment, the request ID includes all the information necessary to specify a particular call to the scenario rules aggregator.

Also, in step 802, the scenario rules aggregator checks whether a scenario ID was passed to it when it was called. If a scenario ID was not specified, the scenario rules aggregator may refer in step 804 to a schedule of scenario IDs to select a scenario to activate for the particular application and/or location under consideration. (The application may be the particular resource allocation program for which the scenario is invoked, for example, a program for allocation of an airport's physical resources, or a program for allocation of an airport's human resources. The location may be a particular business environment in which resource allocation is to be achieved.) Where no scenario ID is specified, the default scenario selected by the scenario rules aggregator may be the entry in the schedule corresponding to the current date or a date specified when the scenario rules aggregator was called (step 806). In alternative embodiments, other default scenario selections may be made. For example, there may be a particular scenario that is always the default selected by the scenario rules aggregator when a scenario ID is not specified.

Having identified the scenario ID (either because it was specified by the user or passed with a function call in step 802, or because it was determined from a schedule or other selection means in step 806), an exemplary scenario rules aggregator then passes the scenario ID to step 808, in which a list of the rule group IDs of the rule groups associated with the scenario is compiled. This list is then passed to step 810, which takes the rule group IDs and extracts from the database information about the members of the rule groups identified by the rule group IDs.

Each rule group's members may include individual rules and/or other rule groups. In step 812, the exemplary scenario rules aggregator compiles a list of the database entries corresponding to all of the members of the rule groups identified in step 810. It then passes the list of rule groups and the list of members of those rule groups to step 818. Step 818 determines whether any rule group members are themselves rule groups. If so, the scenario rules aggregator adds these rule groups to the existing set (step 814) and return to step 812 to augment the list of database entries corresponding to the rule group members by adding the members of those nested rule groups. Because these nested rule groups may also contain further rule groups, step 818 repeats recursively until all levels of nested rule groups have been added to the set. Once it is determined (step 818) that the set of rule group members is complete, the scenario rules aggregator passes the set to step 820, which compiles a list of all the rule IDs corresponding to rules that belong to the rule groups in the set.

The scenario rules aggregator may then pass the request ID, the scenario ID, and the list of rule IDs to step 822, which saves the rule ID set into a structure in the database that is labeled with the scenario ID and request ID. At this step the scenario rules aggregator may also delete any pre-existing database entries that have the same scenario ID and/or same request ID as the current scenario. Thus the most recent aggregation of rules under a particular scenario ID may overwrite any previous aggregation under the same scenario ID.

Finally, in step 824, the scenario rules aggregator passes the scenario to the resource allocation application, which applies the scenario to the operational data in order to optimize resource allocation according to the rules associated with the active scenario. In an exemplary embodiment, the scenario rules aggregator passes the scenario ID and request ID to the resource allocation application, and the resource allocation application may use these IDs to link into the database structure saved in step 822 to apply only those rules that are in the scenario. As discussed previously and as illustrated schematically in FIG. 1, the resource allocation program may then apply the rules to the operational data and generate optimized resource allocation plans as output.

Creating and Editing Scenarios, Rules, and Rule Groups.

As mentioned previously, in embodiments of the scenario editing system, there may be means for users to create and edit scenarios, rule groups, and rules, as well as create links among scenarios, rule groups, and rules. In an exemplary embodiment of the scenario editing system, an interface is provided to the user that makes the underlying database and relationships largely transparent to the user. FIG. 9 provides a schematic illustration of the logic underlying some of the features of an exemplary embodiment of a scenario editor 900. The functions illustrated in FIG. 9 may be invoked by a user or called automatically by a scenario editing script or other program.

If the function 902 for creating a scenario, a rule group, or a rule is called, the system may first prompt (904) for a name for the scenario, rule group, or rule. If the function 902 is invoked to create a rule group or a scenario, the system may generate a unique ID for the new rule group or scenario (912) and passes the ID to the database manager 914 which creates the appropriate entries in the database 976. (In any instance in which the database manager 914 is creating or editing entries in the database 976, it may first run a validity check on the data (step 974) and display an error message 972 if the data it is attempting to write to the database 976 is invalid.) If the function 902 is invoked to create a rule, then the system may determine (step 908) whether any additional data is required to initialize the rule. Such data may include any of the rule fields and/or parameters such as those provided in the exemplary rules discussed above. If no additional data is required, the system may generate a rule ID (step 912) and pass it to the database manager 914 for entry in the database 976. If additional data is required, the system may prompt for entry of that data (step 910). Once data entry is complete the system may generate a rule ID (step 912) and pass it along with the rule data to the database manager 914 for entry in the database 976.

If command 916 for the deletion of a scenario, rule group, or rule is invoked, an exemplary scenario editor may first check (step 918) whether references to the scenario, rule group, or rule exist in other scenarios, rule groups, and/or rules. If so, the system may generate an error message 920 which may indicate any references that exist, and/or prompt for additional instructions or information. If no references exist the system may pass instructions to the database manager 914 to delete the scenario, rule group, or rule.

If command 924 for viewing and/or editing a scenario, rule group, and/or rule is invoked, an exemplary scenario editor will fetch (step 926) the data associated with the scenario ID, rule group ID, or rule ID from the database 976 via the database manager 914. The system may then display the data (step 928) to the user. If the user enters changes to the data (step 930), the database manager 914 may then save the revised scenario, rule group, and/or rule to the database 976. Before saving the revised data, an exemplary scenario editor may first check (step 932) whether references to and from other data elements (such as other scenarios, rule groups, and/or rules) remain valid in the edited scenario, rule group, and/or rule, and display an error message 922 and/or prompt for further information or instructions if there are invalid references.

As mentioned previously, an exemplary scenario editor may allow the user to generate either linked or unlinked copies of scenarios, rule groups, and/or rules. In the embodiment illustrated in FIG. 9, these functions implemented in commands 934 (copy), 944 (link), and 952 (unlink). The copy function 934 begins by fetching (step 936) from the database 976 (via the database manager 914) the data associated with the scenario, rule group, or rule to be copied. A copy of this data is then written to a cache file (step 938). When the link command 944 is invoked, the system fetches the data (step 946) from the cache file. To create a link, the system will generate pointers to the data (step 940) and write them to the database 976.

In an exemplary embodiment, when creating a link (step 944) a scenario editor uses pointers between data elements to effectively create two distinct views of the same data. For example, where the system creates a link between two scenarios, there may be only one underlying instance of the linked data stored in the database, but pointers to that single instance of the data exist in both scenarios. Thus, changes to the data that occur in one scenario are reflected within the other.

In contrast to linking, when the copy command (step 934) is invoked, an exemplary scenario editor will create a separate, distinct replica of the underlying data itself, issuing to each copied data element a new, unique ID (rule ID, rule group ID, or scenario ID, depending upon what is being copied) (step 950). Copied data elements are thus separately referred to, such that changes to the original will not be reflected in the copy. When carrying out this copying task, an exemplary scenario editor will ensure that referential integrity between data elements is maintained by analyzing scenarios for data discrepancies and reporting possible violations (steps 950, 942). For example, after making a copy RG1′ of a rule group RG1 and its associated rules, an exemplary scenario editor may check to make sure that no pointers within RG1′ point back to objects within RG1. Thus, step 942 may include checking to make sure that all copied items received new, unique IDs, that no pointers in the copy point to data outside the copy, and/or that all pointers within the copied structure point to objects that are extant in the database.

When the command 952 to unlink previously linked data is invoked, the system also creates distinct, exact copies of the linked data elements and issues them new unique IDs, similarly to the execution of the copy command. The pointers which previously designated the data as linked may be reassigned so that the formerly linked data elements are now separately referred to within each scenario. Once unlinking has occurred, changes to the data will not be reflected across previously linked scenarios. The unlinking operation may also be followed by a check of the referential integrity as in step 942 described above.

Finally, an exemplary scenario editor may include functions for exporting (958) and importing (966) scenarios from some external source (964). When executing these functions the scenario editor may prompt for a file path for the external file (steps 960, 968) or be passed a file path when called by a script or program. The system may then read the scenario data from the database and write to the external file, or vice versa.

The methods and systems described herein are not limited to a particular hardware or software configuration, and may find applicability in many computing or processing environments. The methods and systems can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted.

As provided herein, the processor(s) can thus be embedded in one or more devices that can be operated independently or together in a networked environment, where the network can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a microprocessor” and “a processor”, or “the microprocessor” and “the processor,” can be understood to include one or more microprocessors that can communicate in a stand-alone and/or a distributed environment(s), and can thus can be configured to communicate via wired or wireless communications with other processors, where such one or more processor can be configured to operate on one or more processor-controlled devices that can be similar or different devices. Use of such “microprocessor” or “processor” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communications protocols, and unless otherwise specified, can be arranged to include a combination of external and internal memory devices, where such memory can be contiguous and/or partitioned based on the application. Accordingly, references to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, can include one or more intranets and/or the internet. References herein to microprocessor instructions or microprocessor-executable instructions, in accordance with the above, can be understood to include programmable hardware.

Unless otherwise stated, use of the word “substantially” can be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun can be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, can be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, can be made by those skilled in the art. Accordingly, it will be understood that the following are not to be limited to the embodiments disclosed herein, can include practices otherwise than specifically described, and are to be interpreted as broadly as allowed under the law.

What is claimed is:

1. A scenario-management system for use in a resource-allocation system, comprising:
a central database comprising a plurality of business rules, each of the business rules corresponding to a rule ID; and
a processor configured to:
receive a scenario ID corresponding to an active scenario, the active scenario being associated with a set of business rules in the database;
create a list of the rule IDs corresponding to the set of business rules; and
pass the list to a resource-allocation module.

2. A scenario-management system as in claim 1, wherein:
at least some business rules in the set of business rules associated with the scenario are organized into at least one rule group.

3. A scenario-management system for use in a resource-allocation system, comprising:
a central database comprising a plurality of business rules, each of the business rules corresponding to a rule ID; and
a processor configured to:
refer to a schedule associating at least one scenario ID with at least one time period, to identify a scenario ID corresponding to a scenario associated with a specified time, the scenario being associated with a set of business rules in the database;
create a list of the rule IDs corresponding to the set of business rules; and
pass the list to a resource-allocation module.

4. A scenario-management system as in claim 3, wherein:
at least some business rules in the set of business rules associated with the scenario are organized into at least one rule group.

5. A scenario editor for use with a resource-allocation system, comprising:
means for creating, editing, and storing objects in a database, the objects comprising at least one business rule associated with a rule ID and at least one scenario associated with a scenario ID and further associated with at least one business rule; and
means for creating links among selected objects, such that changes to a first object are reflected in a second object linked to the first object.

6. A scenario editor as in claim 5, further comprising means for associating a time period with a scenario ID corresponding to an active scenario for the time period.

7. A scenario editor as in claim 5, wherein the objects further comprise at least one rule group associated with a rule group ID and further associated with at least one business rule.

8. A scenario editor as in claim 7, wherein at least one of the at least one scenarios is further associated with at least one rule group.

9. A scenario editor as in claim 7, further comprising means for associating a time period with a scenario ID corresponding to an active scenario for the time period.

10. A scenario-editor as in claim 7, wherein at least one rule group further contains at least one different rule group.

11. A scenario-management system for use with a resource-allocation system comprising:
means for creating, editing, and storing objects in a database, the objects comprising at least one business rule associated with a rule ID and at least one scenario associated with a scenario ID and further associated with at least one business rule;
means for creating links among selected objects, such that changes to a first object are reflected in a second object linked to the first object; and
a processor configured to:
receive a scenario ID corresponding to an active scenario, the active scenario being associated with a set of business rules in the database;
create a list of the rule IDs corresponding to the set of business rules associated with the active scenario; and
pass the list to a resource-allocation module.

12. A scenario-management system as in claim 11, wherein the objects further comprise at least one rule group associated with a rule group ID and further associated with at least one business rule.

13. A scenario-management system as in claim 11, wherein at least one of the at least one scenarios is further associated with at least one rule group.

14. A scenario-management system for use with a resource-allocation system comprising:
means for creating, editing, and storing objects in a database, the objects comprising at least one business rule associated with a rule ID and at least one scenario associated with a scenario ID and further associated with at least one business rule;
means for creating links among selected objects, such that changes to a first object are reflected in a second object linked to the first object; and
a processor configured to:
refer to a schedule associating at least one scenario ID with at least one time period, to identify a scenario ID corresponding to an active scenario associated with a specified time, the active scenario being associated with a set of business rules in the database;
create a list of the rule IDs corresponding to the set of business rules associated with the active scenario; and
pass the list to a resource-allocation module.

15. A scenario-management system as in claim 14, wherein the objects further comprise at least one rule group associated with a rule group ID and further associated with at least one business rule.

16. A scenario-management system as in claim 14, wherein at least one of the at least one scenarios is further associated with at least one rule group.
